(19) United States
(12) Patent Application Publication
(10) Pub. No.: US 2025/0271731 A1
(43) Pub. Date: Aug. 28, 2025

(54) PROJECTION LENS MODULE AND PROJECTION DEVICE

(71) Applicant: Coretronic Corporation, Hsin-Chu (TW)

(72) Inventors: Chia-Chi Chung, Hsin-Chu (TW); Chih-Hui Chang, Hsin-Chu (TW)

(73) Assignee: Coretronic Corporation, Hsin-Chu (TW)

(21) Appl. No.: 19/047,640

(22) Filed: Feb. 7, 2025

Related U.S. Application Data
(60) Provisional application No. 63/556,845, filed on Feb. 22, 2024.

(30) Foreign Application Priority Data
Apr. 11, 2024 (CN) 202410433154.3

(51) Int. Cl. G03B 11/04; G02B 7/02; G03B 21/14

(52) U.S. Cl. CPC G03B 11/045; G02B 7/021; G03B 21/142; G03B 21/145

(57) ABSTRACT

A projection lens module including a lens barrel, a lens element assembly, a focus ring and a shielding member is provided. The lens barrel has an accommodation space and a light exit opening. The lens element assembly is disposed in the accommodation space. The focus ring is disposed on an outer side of the lens barrel, and the focus ring is configured to drive the lens barrel to rotate relative to an optical axis of the lens element assembly. The shielding member is disposed on the outer side of the lens barrel. The shielding member is connected to the focus ring and covers a part of the light exit opening of the lens barrel. The shielding member is configured to move in a first direction with the focus ring, and a relative distance between the shielding member and the focus ring on the optical axis is unchanged.

### CROSS-REFERENCE TO RELATED APPLICATION

This application claims the priority benefit of U.S. provisional application Ser. No. 63/556,845 filed on Feb. 22, 2024, and China application serial no. 202410433154.3 filed on Apr. 11, 2024. The entirety of the above-mentioned patent application is hereby incorporated by reference herein and made a part of this specification.

### BACKGROUND

### Technical Field

The invention relates to an optical module and an electronic device, and particularly relates to a projection lens module and projection device.

### Description of Related Art

Projection device is a display device used to produce large-size images, which has been constantly improved along with evolution and innovation of science and technology. An imaging principle of the projection device is to convert an illumination beam generated by an illumination system into an image beam through a light valve, and then project the image beam onto a projection target (such as a screen or wall) through a projection lens to form a projection image.

The projection device transmits the illumination beam to the light valve via the illumination system, the light valve forms the image beam and reflect the image beam out of the projection lens. When the image beam is reflected by the light valve, some stray light (or reflected light) may cause light and shadow in an invalid projection region outside an effective projection region for human eyes to observe. As a result, user's viewing experience when viewing images in the effective projection region may be affected. Therefore, it is necessary to use a shielding plate to block the stray light. However, an existing shielding plate design has problems of requiring manual installation or removal, increasing an overall volume of the projection device, and insufficient reliability.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection lens module and a projection device, which are adapted to continuously block stray light at a specific position of a light exit opening of the projection lens module when adjusting a focal length, thereby improving optical quality of projection.

Additional aspects and advantages of the present invention will be set forth in the description of the techniques disclosed in the invention.

In order to achieve one or a portion of or all of the objects or other objects, an embodiment of the invention provides a projection lens module including a lens barrel, a lens element assembly, a focus ring and a shielding member. The lens barrel has an accommodation space and a light exit opening. The lens element assembly is disposed in the accommodation space. The focus ring is disposed on an outer side of the lens barrel, and the focus ring is configured to drive the lens barrel to rotate relative to an optical axis of the lens element assembly. The shielding member is disposed on the outer side of the lens barrel. The shielding member is connected to the focus ring and covers a part of the light exit opening of the lens barrel. The shielding member is configured to move in a first direction with the focus ring, and a relative distance between the shielding member and the focus ring on the optical axis is unchanged.

In order to achieve one or a portion of or all of the objects or other objects, an embodiment of the invention provides a projection device including an illumination system, at least one light valve and a projection lens module. The illumination system is configured to provide an illumination beam. The at least one light valve is disposed on a transmission path of the illumination beam to convert the illumination beam into an image beam. The projection lens module is disposed on a transmission path of the image beam and is configured to project the image beam out of the projection device. The projection lens module includes a lens barrel, a lens element assembly, a focus ring and a shielding member. The lens barrel has an accommodation space and a light exit opening. The lens element assembly is disposed in the accommodation space. The focus ring is disposed on an outer side of the lens barrel, and the focus ring is configured to drive the lens barrel to rotate relative to an optical axis of the lens element assembly. The shielding member is disposed on the outer side of the lens barrel. The shielding member is connected to the focus ring and covers a part of the light exit opening of the lens barrel. The shielding member is configured to move in a first direction with the focus ring, and a relative distance between the shielding member and the focus ring on the optical axis is unchanged.

Based on the above descriptions, the embodiments of the invention have at least one of the following advantages or effects. The projection lens module and projection device of the embodiments the invention, the shielding member configured to block stray light is mechanically designed so that the shielding member and the focus ring are adapted to move in the same direction, and the relative distance between the shielding member and the focus ring on the optical axis is unchanged. Therefore, when the projection lens module adjusts the focal length, there is no need to additionally disassemble or move the shielding member. In this way, when the projection lens module adjusts the focal length, the stray light at a specific position of the light exit opening of the projection lens module is continuously blocked, thereby improving the optical quality of projection.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a partial three-dimensional view of a projection device according to an embodiment of the invention.

FIG. 3 is a schematic three-dimensional view of a projection lens module of FIG. 2.

FIG. 4 is a schematic front view of the projection lens module of FIG. 3.

FIG. 5 is a schematic cross-sectional view of the projection lens module of FIG. 3.

FIG. 6 is a partial three-dimensional exploded view of the projection device in FIG. 2.

FIG. 7 is a schematic three-dimensional view of a projection lens module according to another embodiment of the invention.

FIG. 8A is a schematic three-dimensional view of a partial structure of the projection lens module of FIG. 7.

FIG. 8B is a schematic front view of a shielding member according to an embodiment of the invention.

FIG. 9 is a schematic rear view of the projection lens module of FIG. 7.

FIG. 10 is a schematic cross-sectional view of the projection lens module of FIG. 7.

FIG. 11 is a schematic three-dimensional exploded view of the projection lens module of FIG. 7.

FIG. 12 is a schematic partial front view of the projection lens module of FIG. 7.

FIG. 13 is a schematic three-dimensional view of a partial structure of a projection lens module according to another embodiment of the invention.

FIG. 14 is a schematic partial front view of the projection lens module of FIG. 13.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

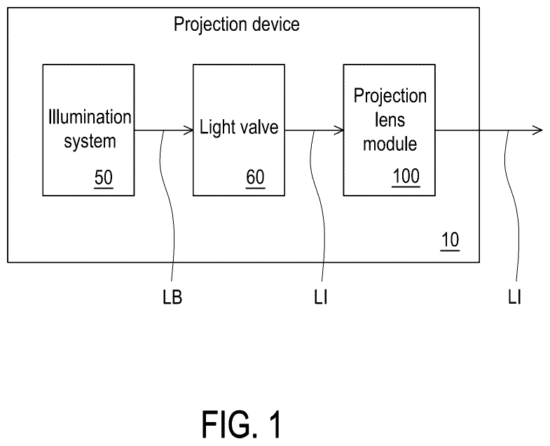

FIG. 1 is a schematic diagram of a projection device according to an embodiment of the invention. Referring to FIG. 1, the embodiment provides a projection device (projector) 10, which includes an illumination system 50, at least one light valve 60 and a projection lens module 100. The illumination system 50 is configured to provide an illumination beam LB. The at least one light valve 60 is disposed on a transmission path of the illumination beam LB to convert the illumination beam LB into an image beam LI. The projection lens module 100 is disposed on a transmission path of the image beam LI, and is configured to project the image beam LI out of the projection device 10 to a projection target (not shown), such as a screen or a wall.

The illumination system 50 is configured to provide the illumination beam LB. For example, in the embodiment, the illumination system 50 includes a plurality of light-emitting elements. The illumination system 50 is configured to provide illumination beams LB with beams of different wavelengths. The plurality of light-emitting elements are, for example, light-emitting diodes (LEDs), laser diodes (LDs), or a combination thereof. The illumination system 50 may also be equipped with optical elements such as a wavelength conversion element (for example, phosphor wheel), a light uniformizing element (for example, rod, or lens array), a filter element (for example, filter wheel), a plurality of light splitting and combining (for example, dichroic mirror) elements, etc. The embodiments of the invention do not limit the type or form of the illumination system 50 in the projection device 10, and detailed structure and implementation thereof may be provided with sufficient teachings, suggestions and implementation instructions from common knowledge in the technical field, which will not be repeated.

The light valve 60 is, for example, a reflective optical modulator such as a liquid crystal on silicon panel (LCoS panel) or a digital micro-mirror device (DMD), etc. In some embodiments, the light valve 60 may also be a transmissive optical modulator such as a transparent liquid crystal panel, an electro-optical modulator, a magneto-optic modulator, or an acousto-optic modulator, etc. The embodiments of the invention does not limit a pattern and type of the light valve 60. Detailed steps and implementation methods of the light valve 60 converting the illumination beam LB into the image beam LI may be provided with sufficient teachings, suggestions and implementation instructions from common knowledge in the technical field, which will not be repeated. In different embodiments, a number of light valves 60 may be designed from one to three.

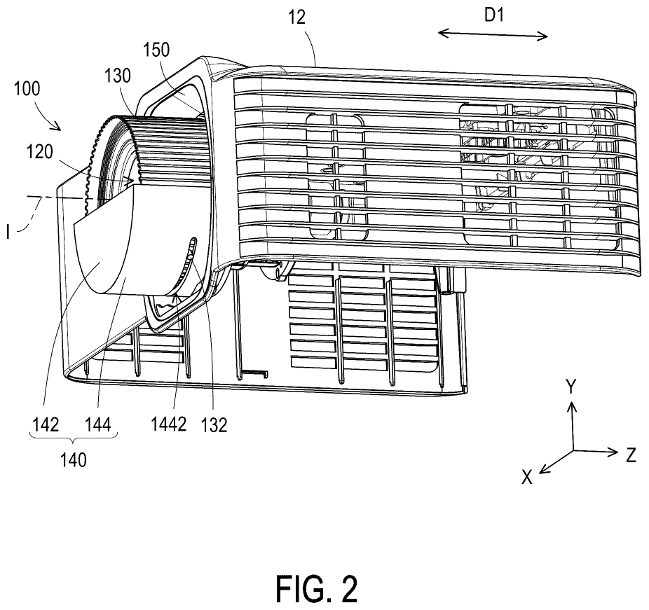

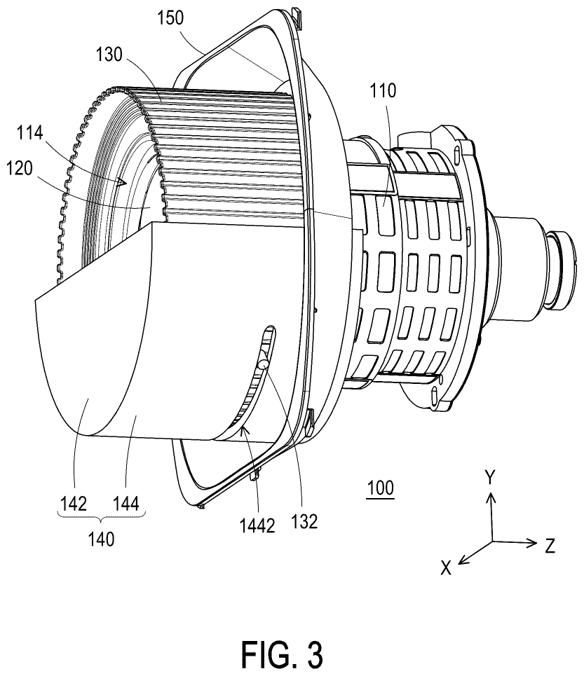

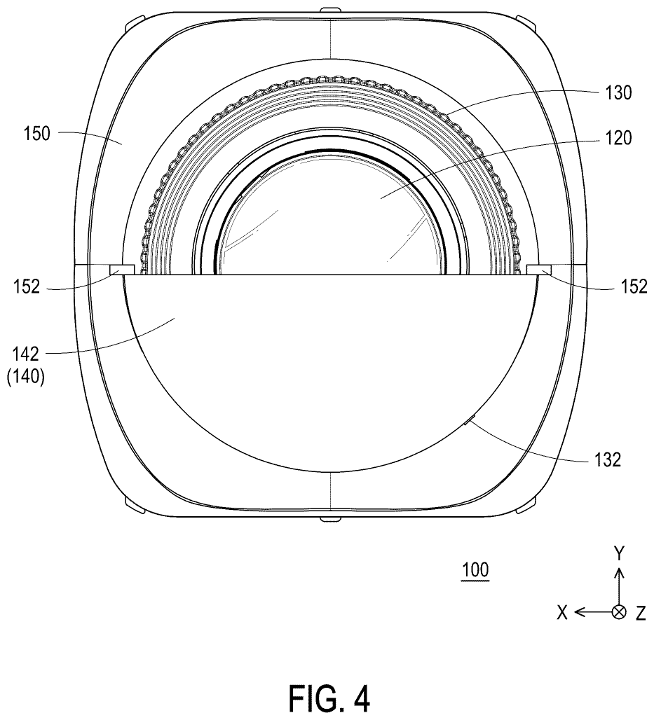

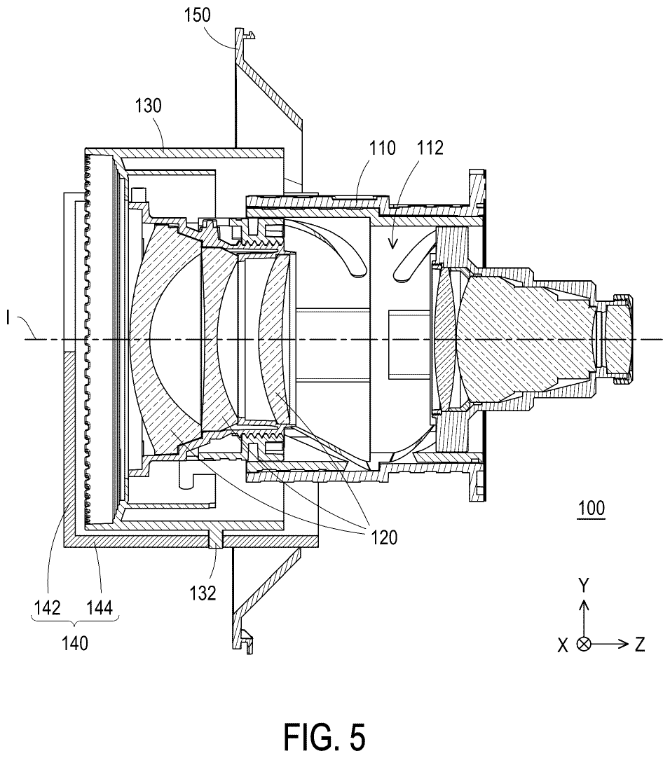

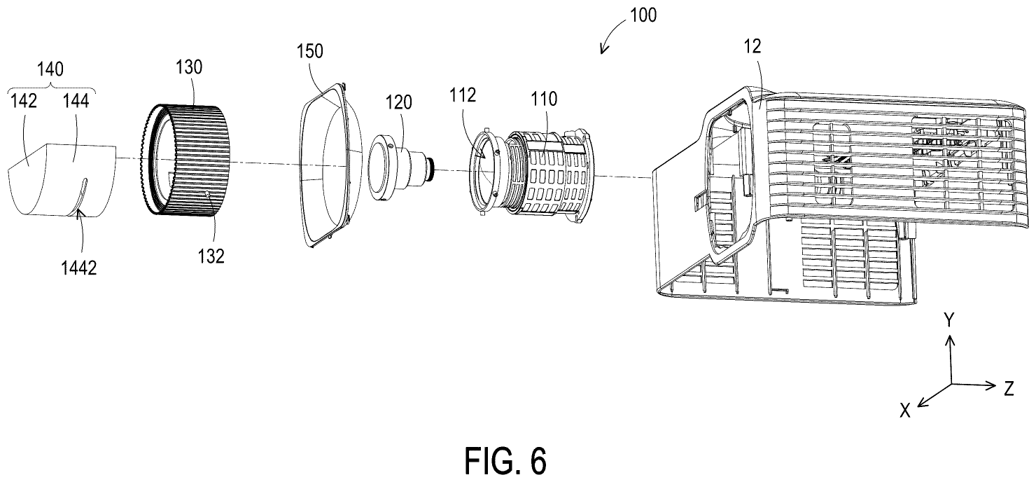

FIG. 2 is a partial three-dimensional view of a projection device according to an embodiment of the invention. FIG. 3 is a schematic three-dimensional view of a projection lens module of FIG. 2. FIG. 4 is a schematic front view of the projection lens module of FIG. 3. FIG. 5 is a schematic cross-sectional view of the projection lens module of FIG. 3. FIG. 6 is a partial three-dimensional exploded view of the projection device in FIG. 2. Referring to FIG. 2 to FIG. 6, the projection lens module 100 of the embodiment may be applied to at least the projection device 10 shown in FIG. 1. In the embodiment, the projection lens module 100 includes a lens barrel 110, a lens element assembly 120, a focus ring 130 and a shielding member 140. The lens barrel 110 has an accommodation space 112 and a light exit opening 114. The lens element assembly 120 is disposed in the accommodation space 112 of the lens barrel 110. The lens element assembly 120 includes, for example, a combination of one or more optical lenses with diopter, such as various combinations of non-planar lenses including a biconcave lens, a biconvex lens, a concavo-convex lens, a convexo-concave lens, a plano-convex lens, a plano-concave lens, etc. In an embodiment, the lens element assembly 120 may further include a planar optical lens to project the image beam LI from the light valve 60 to a projection target in a reflective manner. The optical pattern and type of the lens element assembly 120 are not limited by the embodiment of the invention.

The focus ring 130 is disposed on an outer side of the lens barrel 110, and is engaged with the lens barrel 110. The focus ring 130 is configured to drive the lens barrel 110 to rotate relative to an optical axis I of the lens element assembly 120, thereby adjusting a focal length of the projection lens module 100. In the embodiment, the focus ring 130 includes a positioning rod 132 located on an outer side of the focus ring 130 in a circumferential direction, and the positioning rod 132 extends from the focus ring 130 in a direction away from the optical axis I. The shielding member 140 is disposed on the outer side of the lens barrel 110 and the focus ring 130. The shielding member 140 is connected to the focus ring 130 and covers a part of the light exit opening 114 of the lens barrel 110 to block stray light at a specific position of the light exit opening 114 of the projection lens module 100 to improve optical quality of projection. The shielding member 140 is configured to move with the focus ring 130 along a first direction D1 (a positive Z-axis direction or a negative Z-axis direction) parallel to the optical axis I, and a relative distance between the shielding member 140 and the focus ring 130 on the optical axis I is unchanged. The shielding member 140 is, for example, a mask cover. The first direction D1, a second direction D2 (a positive Y-axis direction or a negative Y-axis direction) which perpendicular to the first direction D1, and a third direction D3 (a positive X-axis direction or a negative X-axis direction) which perpendicular to the first direction D1 and the second direction D2 are further defined.

In the embodiment, the focus ring 130 is located between the lens barrel 110 and the shielding member 140, and the shielding member 140 covers a part of the focus ring 130. The shielding member 140 includes a shielding plate 142 and a collar portion 144 connected to the periphery of the shielding plate 142. In the embodiment, the collar portion 144 of the shielding member 140 has a sliding groove 1442, and the positioning rod 132 of the focus ring 130 is disposed through the sliding groove 1442 of the collar portion 144. The sliding groove 1442 is an arc-shaped slot on a side surface of the collar portion 144 in the circumferential direction, and an extending direction of the sliding groove 1442 is perpendicular to the extending direction of the optical axis I. When the focus ring 130 of the projection lens module 100 is rotated to adjust a focal length, as the positioning rod 132 of the focus ring 130 is disposed through the sliding groove 1442 of the collar portion 144, the positioning rod 132 is moved in the sliding groove 1442 of the collar portion 144, and the sliding groove 1442 may limit the movement of the positioning rod 132 in the first direction D1, thereby keeping the relative distance between the shielding member 140 and the focus ring 130 on the optical axis I unchanged. In other words, when the projection lens module 100 adjusts the focal length, there is no need to additionally disassemble or move the shielding member 140. In this way, when the projection lens module 100 adjusts the focal length, the stray light at the specific position of the light exit opening 114 of the projection lens module 100 may be continuously blocked, thereby improving the optical quality of projection.

In the embodiment, the shielding plate 142 of the shielding member 140 is arcuate, and the projection lens module 100 further includes a decorative ring (deco ring) 150, the decorative ring 150 is disposed on the outer side of the lens barrel 110. The decorative ring 150 is located between the lens barrel 110 and a housing 12 of the projection device 10 to fix a relative position of the projection lens module 100 and the housing 12. The decorative ring 150 includes two position-limiting members 152, and the position-limiting members 152 are, for example, plate-shaped, such as stoppers. Both ends of the collar portion 144 of the shielding member 140 respectively abut against the two position-limiting members 152, as shown in FIG. 4. In this way, when the focus ring 130 of the projection lens module 100 is rotated to adjust the focal length, the collar portion 144 of the shielding member 140 abuts against the two position-limiting members 152 of the decorative ring 150, preventing the shielding member 140 from being rotated by the focusing ring 130. As a result, the shielding member 140 is not driven by the focus ring 130 to rotate, and the shielding member 140 may not move along the positive Y-axis direction or the negative Y-axis direction with the focus ring 130. The shielding member 140 may move back and forth (along the positive Z-axis direction or the negative Z-axis direction) together with the lens element assembly 120, so that the region covered by the shielding plate 142 in the projection lens module 100 remains at a position below the optical axis I on a reference plane (XY plane) perpendicular to the optical axis I, and the shielding member 140, being disposed on a transmission path of the stray light may block the stray light projected out of the projection device 10, so that a bright region originally formed by accumulation of stray light is eliminated. In an embodiment, the above-mentioned position-limiting member 152 may not be disposed on the decorative ring 150, but may be disposed on the housing 12 of the projection device 10.

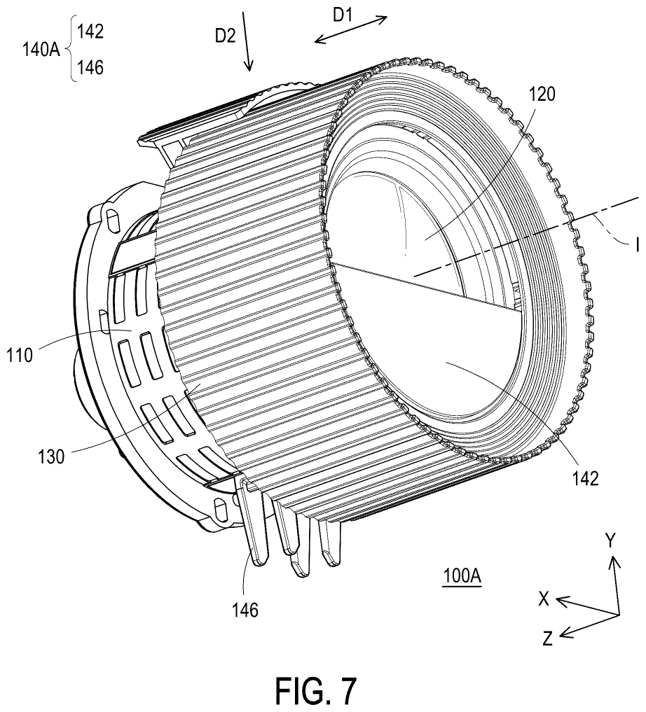

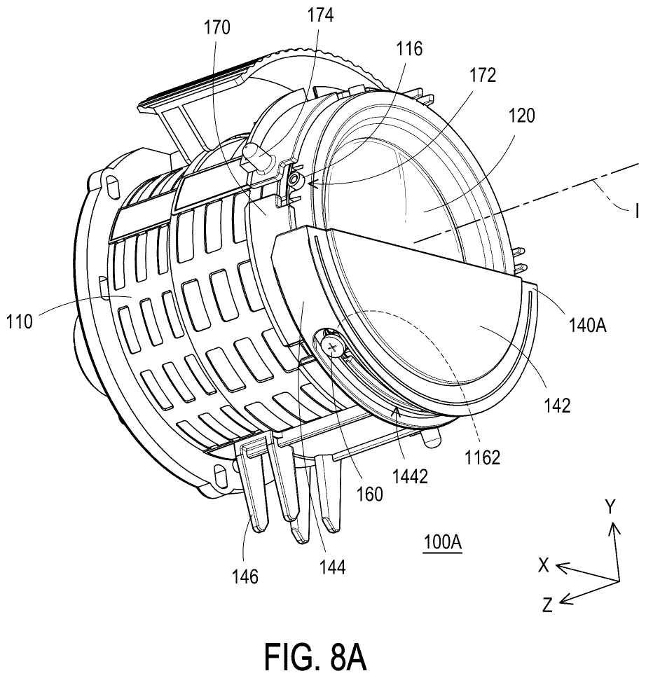

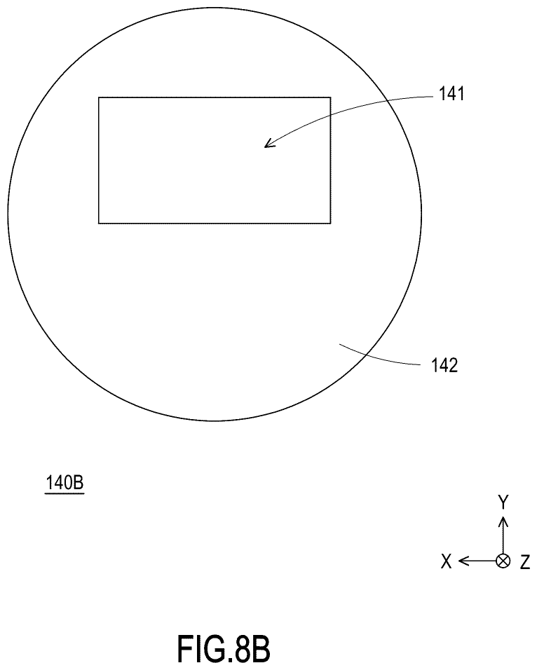

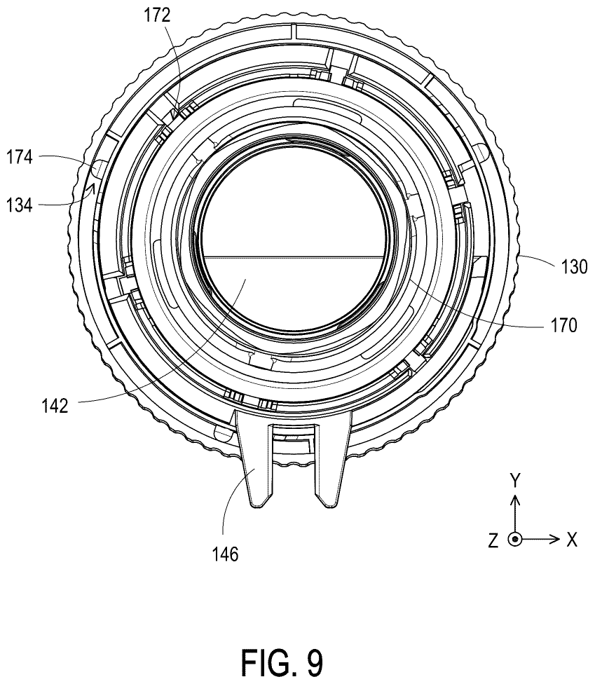

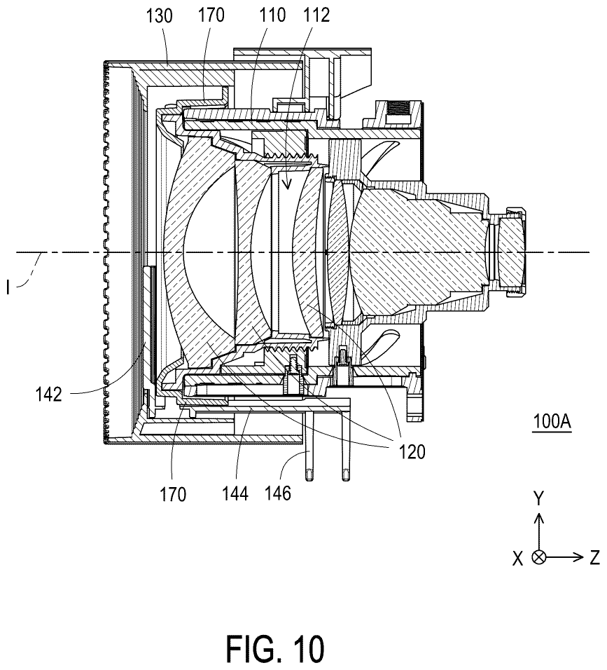

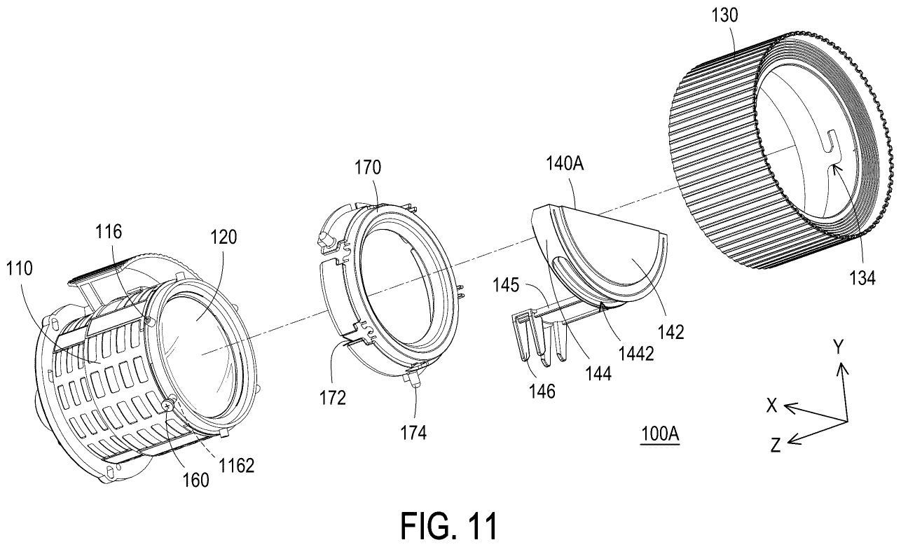

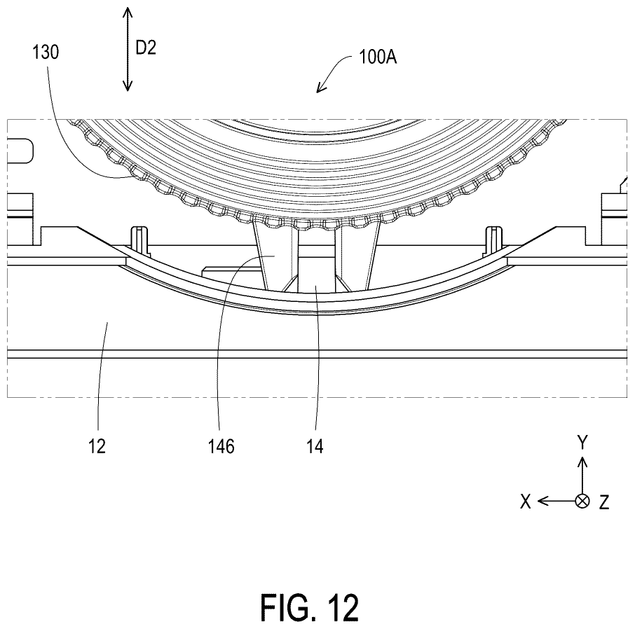

FIG. 7 is a schematic three-dimensional view of a projection lens module according to another embodiment of the invention. FIG. 8A is a schematic three-dimensional view of a partial structure of the projection lens module of FIG. 7. FIG. 9 is a schematic rear view of the projection lens module of FIG. 7. FIG. 10 is a schematic cross-sectional view of the projection lens module of FIG. 7. FIG. 11 is a schematic three-dimensional exploded view of the projection lens module of FIG. 7. FIG. 12 is a schematic partial front view of the projection lens module of FIG. 7. Referring to FIG. 7, FIG. 8A and FIG. 9 to FIG. 12, a projection lens module 100A of the embodiment is similar to the projection lens module 100 shown in FIG. 2. A difference there between is that in the embodiment, a shielding member 140A is located between the lens barrel 110 and the focus ring 130. The focus ring 130 covers a part of the shielding member 140A. In the embodiment, the shielding member 140A includes a shielding plate 142, a collar portion 144 connected to the periphery of the shielding plate 142, and a positioning portion 146 connected to the collar portion 144 and protruding along the second direction D2. The second direction D2 is perpendicular to the first direction D1. The shielding member 140A further includes a connection portion 145 extending along the first direction D1 between the collar portion 144 and the positioning portion 146.

In the embodiment, the lens barrel 110 includes a plurality of first clamping posts 116. The first clamping posts 116 are located on the outer side of the lens barrel 110 in the circumferential direction and extend in a direction away from the optical axis I. In the embodiment, a number of the plurality of first clamping posts 116 is, for example, six, and they are evenly distributed on the outer side of the lens barrel 110. The first clamping posts 116 are, for example, posts or pins. The collar portion 144 of the shielding member 140A has a sliding groove 1442, and at least one of the first clamping posts 116 is disposed through the sliding groove 1442 of the collar portion 144. In the embodiment, the first clamping post 116 disposed through the sliding groove 1442 has a locking hole 1162, and the projection lens module 100A further includes a locking accessory 160, which is locked to the locking hole 1162 of the first clamping post 116 to limit the movement of the shielding member 140A. The locking accessory 160 is, for example, a screw. The locking hole 1162 is, for example, a screw hole. When the focus ring 130 of the projection lens module 100A is rotated to adjust the focal length, as the first clamping post 116 of the lens barrel 110 is disposed through the sliding groove 1442 of the collar portion 144, the first clamping post 116 moves in the sliding groove 1442 of the collar portion 144, and the relative distance between the shielding member 140A and the focus ring 130 on the optical axis I is unchanged. The shielding member 140A moves simultaneously with the lens barrel 110 in the direction of the optical axis I, and the blocking member 140A may not be driven to rotate due to the rotation of the focus ring 130. In other words, when the projection lens module 100A adjusts the focal length, there is no need to additionally disassemble or move the shielding member 140A. In this way, when the projection lens module 100A adjusts the focal length, the stray light at a specific position of the light exit opening 114 of the projection lens module 100A may be continuously blocked, thereby improving the optical quality of projection.

In the embodiment, the projection lens module 100A further includes an adapter ring 170, which is disposed between the lens barrel 110 and the shielding member 140A. The adapter ring 170 includes a plurality of clamping slots 172, and the plurality of first clamping posts 116 of the lens barrel 110 are disposed through the plurality of clamping slots 172, and one of the plurality of first clamping posts 116 disposed through the clamping slot 172 is further disposed through the sliding groove 1442 of the collar portion 144. The clamping slots 172 are, for example, slots. An outer surface of the adapter ring 170 in the circumferential direction includes at least one second clamping post 174, and an inner surface of the focus ring 130 in the circumferential direction includes at least one clamping groove structure (for example, a groove) 134. In the embodiment, a number of the second clamping posts 174 and the clamping groove structures 134 is, for example, three or six, and the second clamping posts 174 are evenly distributed on the outer side of the adapter ring 170 in the circumferential direction. The second clamping post 174 is for example, a post or a pin. The second clamping post 174 of the adapter ring 170 is engaged with the clamping groove structure 134 of the focus ring 130. In an embodiment, the clamping groove structure 134 includes a stop portion (not shown in FIG) and an inclined portion (not shown in FIG) connected to each other. The inclined portion has a design that tapers along with a distance relative to the adapter ring 170. The inclined portion includes a closest end that is closest to the adapter ring 170 and a farthest end that is farthest from the adapter ring 170. The stop portion is connected to the farthest end of the inclined portion. By rotating (for example, counterclockwise) the focus ring 130 or the adapter ring 170, the second clamping post 174 of the adapter ring 170 is gradually engaged and fixed with the stop portion of the clamping groove structure 134 at the inclined portion of the clamping groove structure 134, thereby fixing the adapter ring 170 and the focusing ring 130 to each other. In this way, the focus ring 130 may be fixed to the outer side of the lens barrel 110 through the configuration of the adapter ring 170, and at the same time, the relative distance between the shielding member 140A and the focus ring 130 on the optical axis I is unchanged when the projection lens module 100A adjusts the focal length, and the shielding member 140A is kept not rotating along with the focus ring 130 and continues to block stray light at a specific position of the light exit opening 114 of the projection lens module 100A. In the embodiment, since the shielding member 140A is located between the lens barrel 110 and the focus ring 130, a circumferential side of the focus ring 130 may be used as a position for a user to grasp and rotate the focus ring 130. In an embodiment, the projection lens module 100A may further include a dust cover (not shown in FIG) located on the outer side of the focus ring 130, and the focus ring 130 is located between the shielding member 140A and the dust cover.

In the embodiment, the positioning portion 146 of the shielding member 140A has, for example, two columnar structures extending in the direction of the housing 12 (the negative Y-axis direction), which may be clamped and fixed to the housing 12 of the projection device 10, so that the shielding member 140A and the focus ring 130 may move along the second direction D2, and the relative distance between the shielding member 140A and the focus ring 130 in the second direction D2 is unchanged. In the embodiment, the housing 12 of the projection device 10 includes a position-limiting structure 14. The position-limiting structure 14 extends from the housing 12 toward the direction of the projection lens module 100A (the positive Y-axis direction), and the positioning portion 146 of the shielding member 140A is engaged with the position-limiting structure 14 of the housing 12. In other words, the positioning portion 146 of the shielding member 140A and the position-limiting structure 14 of the housing 12 have corresponding structures with opposite extending directions. The position-limiting structure 14 further has an extension structure extending parallel to the optical axis I. Therefore, in the embodiment, the position-limiting structure 14 may be configured to allow the projection lens module 100A to move along the first direction D1 and/or the second direction D2, thereby driving the shielding member 140A to move along the first direction D1 and/or the second direction D2. In this way, the shielding member 140A of the embodiment has more dimensions of adjustment space, and the shielding member 140A may move back and forth and/or up and down along with the lens element assembly 120. In different embodiments, the position-limiting structure 14 may be selectively connected to or integrally formed with the body of the housing 12.

FIG. 8B is a schematic front view of a shielding member according to an embodiment of the invention. Referring to FIG. 8A and FIG. 8B, in an embodiment, the stray light is only distributed in a lower region outside an effective projection region, so that the shielding plate 142 may be correspondingly designed to block a lower side of the light exit opening 114 of the lens barrel 110, and an outline of the shielding plate 142 is an arcuate shape. In another option of the embodiment, the outline of the shielding plate 142 of the shielding member 140B may be modified from the arcuate shape to a design with a rectangular opening. In this way, it may be applied to situations where stray light is distributed in the lower region, upper region, left region and right region outside the effective projection region. The shielding member 140B may be designed to expose only partial area of the light exit opening 114 of the lens barrel 110 corresponding to the effective projection region, and block the rest area of the light exit opening 114 corresponding to the effective projection region. The effective projection region refers to a region where the image beam LI projected from the projection device 10 forms an image.

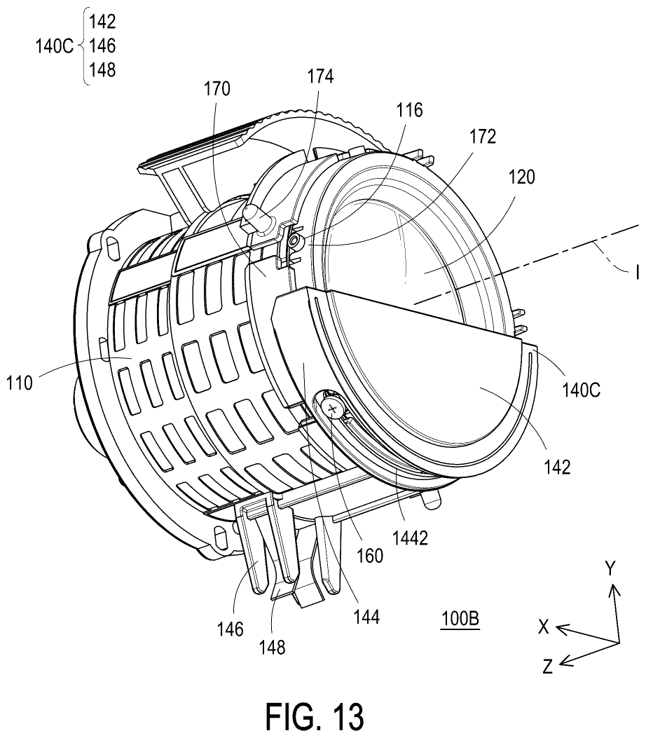

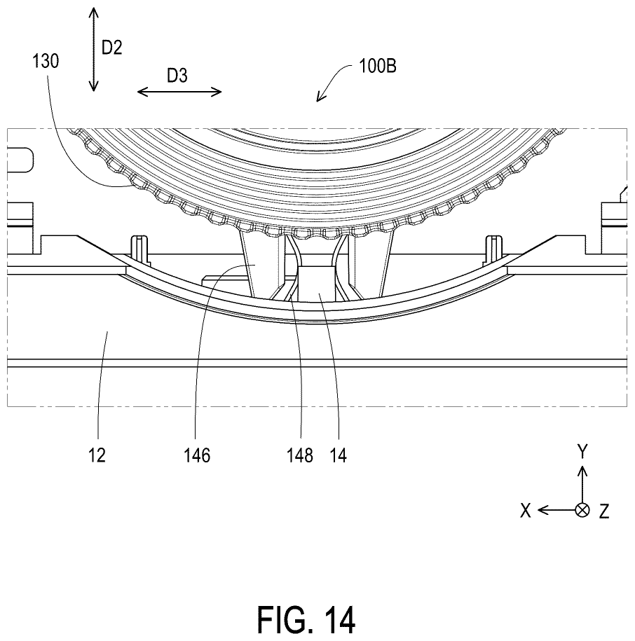

FIG. 13 is a schematic three-dimensional view of a partial structure of a projection lens module according to another embodiment of the invention. FIG. 14 is a schematic partial front view of the projection lens module of FIG. 13. Referring to FIG. 13 and FIG. 14, a projection lens module 100B of the embodiment is similar to the projection lens module 100A shown in FIG.

8A, and a difference there between is that in the embodiment, a shielding member 140C further includes an elastic member 148, and the elastic member 148 may be a compressible elastic piece made of metal (for example, a stainless steel elastic piece). The elastic member 148 is disposed on an inner side of the positioning portion 146, and is located between the position-limiting structure 14 of the housing 12 and the positioning portion 146, and clamps the positioning-limiting structure 14. A width between the two columnar structures of the positioning portion 146 extending toward the housing 12 in the third direction D3 is greater than a width of the position-limiting structure 14 of the housing 12 in the third direction D3. Through an elastic force of the elastic member 148, the elastic member 148 is configured to allow the shielding member 140C and the focus ring 130 to move along the third direction D3, and the relative distance between the shielding member 140C and the focus ring 130 in the third direction D3 is unchanged. The third direction D3 is perpendicular to the second direction D2 and the first direction D1 respectively. In this way, the shielding member 140C of the embodiment has more dimensions of adjustment space. The shielding member 140C may move back and forth (along the first direction D1) and/or up and down (along the second direction D2) and/or move to the left or right (along the third direction D) along with the lens element assembly 120.

In summary, the projection lens module and the projection device of the embodiments of the invention have at least one of the following advantages or effects. The projection lens module and projection device of the embodiments the invention, the shielding member configured to block stray light is mechanically designed so that the shielding member and the focus ring are adapted to move in the same direction, and the relative distance between the shielding member and the focus ring on the optical axis is unchanged. Therefore, when the projection lens module adjusts the focal length, there is no need to additionally disassemble or move the shielding member. In this way, when the projection lens module adjusts the focal length, the stray light at a specific position of the light exit opening of the projection lens module is continuously blocked, thereby improving the optical quality of projection.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection lens module, comprising a lens barrel, a lens element assembly, a focus ring and a shielding member, wherein
the lens barrel has an accommodation space and a light exit opening;
the lens element assembly is disposed in the accommodation space;
the focus ring is disposed on an outer side of the lens barrel, and the focus ring is configured to drive the lens barrel to rotate relative to an optical axis of the lens element assembly; and
the shielding member is disposed on the outer side of the lens barrel, the shielding member is connected to the focus ring and covers a part of the light exit opening of the lens barrel, the shielding member is configured to move along a first direction with the focus ring, and a relative distance between the shielding member and the focus ring on the optical axis is unchanged.

2. The projection lens module as claimed in claim 1, wherein the focus ring is located between the lens barrel and the shielding member, and the shielding member covers a part of the focus ring.

3. The projection lens module as claimed in claim 2, wherein the shielding member comprises a shielding plate and a collar portion connected to a periphery of the shielding plate.

4. The projection lens module as claimed in claim 3, wherein the focus ring comprises a positioning rod, the positioning rod is located on an outer side of the focusing ring, the collar portion of the shielding member has a sliding groove, and the positioning rod of the focus ring is disposed through the sliding groove of the collar portion.

5. The projection lens module as claimed in claim 3, wherein the shielding plate is arcuate, and the projection lens module further comprises a decorative ring disposed on the outer side of the lens barrel, the decorative ring comprises two position-limiting members, and two ends of the collar portion respectively abut against the two position-limiting members.

6. The projection lens module as claimed in claim 1, wherein the shielding member is located between the lens barrel and the focus ring, and the focus ring covers a part of the shielding member.

7. The projection lens module as claimed in claim 6, wherein the shielding member comprises a shielding plate, a collar portion connected to a periphery of the shielding plate, and a positioning portion connected to the collar portion and protruding in a second direction, the positioning portion is configured to allow the shielding member and the focus ring to move along the second direction, and a relative distance between the shielding member and the focus ring in the second direction is unchanged, wherein the second direction is perpendicular to the first direction.

8. The projection lens module as claimed in claim 7, wherein the shielding member further comprises an elastic member disposed on an inner side the positioning portion, the elastic member is configured to allow the shielding member and the focus ring to move along a third direction, and a relative distance between the shielding member and the focus ring in the third direction is unchanged, and the third direction is perpendicular to the second direction and the first direction respectively.

9. The projection lens module as claimed in claim 7, wherein the lens barrel comprises a plurality of first clamping posts located on the outer side of the lens barrel, the collar portion of the shielding member has a sliding groove, and at least one of the clamping posts is disposed through the sliding groove of the collar portion.

10. The projection lens module as claimed in claim 9, wherein at least one of the plurality of first clamping posts has a locking hole, and the projection lens module further comprises a locking accessory that is locked to the locking hole to limit movement of the shielding member.

11. The projection lens module as claimed in claim 9, wherein the projection lens module further comprises an adapter ring disposed between the lens barrel and the shielding member, the adapter ring comprises a plurality of clamping grooves, and the plurality of first clamping posts of the lens barrel are disposed through the plurality of clamping grooves.

12. The projection lens module as claimed in claim 11, wherein an outer surface of the adapter ring comprises at least one second clamping post, an inner surface of the focus ring comprises at least one clamping groove structure, and the at least one second clamping post of the adapter ring is engaged with the at least one clamping groove structure to fix the focus ring.

13. The projection lens module as claimed in claim 7, wherein the shielding plate is arcuate or has a rectangular opening.

14. A projection device, comprising an illumination system, at least one light valve and a projection lens module, wherein:
the illumination system is configured to provide an illumination beam;
the at least one light valve is disposed on a transmission path of the illumination beam to convert the illumination beam into an image beam; and
the projection lens module is disposed on a transmission path of the image beam and is configured to project the image beam out of the projection device, the projection lens module comprises a lens barrel, a lens element assembly, a focus ring and a shielding member, wherein
the lens barrel has an accommodation space and a light exit opening;
the lens element assembly is disposed in the accommodation space;
the focus ring is disposed on an outer side of the lens barrel, and the focus ring is configured to drive the lens barrel to rotate relative to an optical axis of the lens element assembly; and
the shielding member is disposed on the outer side of the lens barrel, the shielding member is connected to the focus ring and covers a part of the light exit opening of the lens barrel, the shielding member is configured to move along a first direction with the focus ring, and a relative distance between the shielding member and the focus ring on the optical axis is unchanged.

15. The projection device as claimed in claim 14, wherein the focus ring is located between the lens barrel and the shielding member, and the shielding member covers a part of the focus ring.

16. The projection device as claimed in claim 15, wherein the shielding member comprises a shielding plate and a collar portion connected to a periphery of the shielding plate.

17. The projection device as claimed in claim 16, wherein the focus ring comprises a positioning rod, the positioning rod is located on an outer side of the focusing ring, the collar portion of the shielding member has a sliding groove, and the positioning rod of the focus ring is disposed through the sliding groove of the collar portion.

18. The projection device as claimed in claim 16, wherein the shielding plate is arcuate, and the projection lens module further comprises a decorative ring disposed on the outer side of the lens barrel and connected to a housing of the projection device, the decorative ring comprises two position-limiting members, and two ends of the collar portion respectively abut against the two position-limiting members.

19. The projection device as claimed in claim 14, wherein the shielding member is located between the lens barrel and the focus ring, and the focus ring covers a part of the shielding member.

20. The projection device as claimed in claim 19, wherein the shielding member comprises a shielding plate, a collar portion connected to a periphery of the shielding plate, and a positioning portion connected to the collar portion and protruding in a second direction, the positioning portion is engaged with a position-limiting structure of a housing of the projection device, and the positioning portion is configured to allow the shielding member and the focus ring to move along the second direction, and a relative distance between the shielding member and the focus ring in the second direction is unchanged, wherein the second direction is perpendicular to the first direction.

21. The projection device as claimed in claim 20, wherein the position-limiting structure is configured to allow the shielding member to move along in the first direction and/or the second direction.

22. The projection device as claimed in claim 20, wherein the shielding member further comprises an elastic member disposed on an inner side the positioning portion, and located between the position-limiting structure of the housing and the positioning portion, the elastic member is configured to move the shielding member and the focus ring in a third direction, and a relative distance between the shielding member and the focus ring in the third direction is unchanged, and the third direction is perpendicular to the second direction and the first direction respectively.

23. The projection device as claimed in claim 20, wherein the lens barrel further comprises a plurality of first clamping posts located on the outer side of the lens barrel, the collar portion of the shielding member has a sliding groove, and at least one of the clamping posts is disposed through the sliding groove of the collar portion.

24. The projection device as claimed in claim 23, wherein at least one of the plurality of first clamping posts has a locking hole, and the projection lens module further comprises a locking accessory that is locked to the locking hole to limit movement of the shielding member.

25. The projection device as claimed in claim 23, wherein the projection lens module further comprises an adapter ring disposed between the lens barrel and the shielding member, the adapter ring comprises a plurality of clamping grooves, and the plurality of first clamping posts of the lens barrel are disposed through the plurality of clamping grooves.

26. The projection device as claimed in claim 25, wherein an outer surface of the adapter ring comprises at least one second clamping post, an inner surface of the focus ring comprises at least one clamping groove structure, and the at least one second clamping post of the adapter ring is engaged with the at least one clamping groove structure to fix the focus ring.

27. The projection device as claimed in claim 20. wherein the shielding plate is arcuate or has a rectangular opening.
